(19) United States
(12) Patent Application Publication
(10) Pub. No.: US 2005/0071666 A1
(43) Pub. Date: Mar. 31, 2005

(54) Location sensitive software execution

(75) Inventors: Simon Chu, Chapel Hill, NC (US); Richard Alan Dayan, Raleigh, NC (US); Jeffery Bart Jennings, Raleigh, NC (US); David B. Rhoades, Raleigh, NC (US)

Correspondence Address: DILLON & YUDELL LLP, 8911 N. CAPITAL OF TEXAS HWY.,, SUITE 2110, AUSTIN, TX, 78759, US

(73) Assignee: International Business Machines Corporation, Armonk, NY (US)

(21) Appl. No.: 10/675,614

(22) Filed: Sep. 30, 2003

(51) Int. Cl. H04L 9/00

(52) U.S. Cl. 713/200

(57) ABSTRACT

A method and system for managing software according to a physical location of a computer that is to execute the software. The operating system of the computer is modified to contain a location service that is able to determine the exact physical location of the computer. When the computer's operating system requests that a software application be loaded into system memory, the computer's location service determines the exact current physical location of the computer using a satellite Global Positioning System (GPS) or similar system. This location is compared to a list of authorized location ranges. If the computer is within an authorized location range, the software is allowed to load into system memory and execute as long as the computer remains within the authorized area. If the computer is not within an authorized area, then the software is not allowed to load into system memory and thus cannot execute.

### BACKGROUND OF THE INVENTION

1. Technical Field

The present invention relates in general to the field of computers, and in particular to client computers on a network. Still more particularly, the present invention relates to a method and system for restricting execution of a software program based on a current physical location of the client computer.

2. Description of the Related Art

As computers become more portable, security issues regarding the software that they run has become a complex issue. For example, current United States laws prohibit the exportation of 128-bit encryption programs, but not 56-bit encryption programs. This prohibition applies not only to software on CD-ROM's and other loadable media, but also to that loaded into a non-volatile memory (NVM), either as a packaged programmable read only memory (PROM) or in the NVM of a computer. As persons travel freely between countries, customs agents rarely, if ever, check the contents of a computer memory for unauthorized software for a particular country.

Similarly, there are certain areas within a domestic facility where the owner of the facility restricts software use. For example, certain enterprises may have a policy that proprietary software is allowed to run only in certain areas of the enterprise campus, such as within a research laboratory, in order to protect the intellectual property of the enterprise. As with the example above directed to custom agents, it is rare that an enterprise will inspect a computer's memory to determine if unauthorized software is leaving a restricted area or the entire campus.

Therefore, there is a need for a method and system that permits software to be loaded and executed only if the executing computer is in an authorized physical location, whether that area be a particular country, state, city or building/room of an enterprise.

### SUMMARY OF THE INVENTION

The present invention is thus directed to a method and system for managing software according to a physical location of a computer that is to execute the software. The operating system of the computer is modified to include a location service that is able to determine the exact physical location of the computer. When the computer's operating system requests that an application be loaded into system memory, the computer's location service determines the exact current physical location of the computer using a satellite Global Positioning System (GPS) or similar system. This location is then compared to a list of authorized location ranges. If the computer is within an authorized location range, the application is allowed to load into system memory and execute as long as the computer remains within the authorized area. If the computer is not in an authorized area, then the application is not allowed in system memory and cannot execute.

The above, as well as additional purposes, features, and advantages of the present invention will become apparent in the following detailed written description.

### BRIEF DESCRIPTION OF THE DRAWINGS

The novel features believed characteristic of the invention are set forth in the appended claims. The invention itself, however, as well as a preferred mode of use, further purposes and advantages thereof, will best be understood by reference to the following detailed description of an illustrative embodiment when read in conjunction with the accompanying drawings, where:

FIG. 1 is a block diagram of a preferred computer system used with the present invention;

FIG. 2 illustrates additional details of the content of system memory in the preferred computer system of FIG. 1;

FIG. 3 is a flow-chart of steps taken in accordance with the present invention to manage installation and execution of software according to physical location parameters; and

FIG. 4 is a diagram of a room in an enterprise that has a local transmitter, whose signal is confined to one area, that broadcasts a location signal code to the client computer identifying where the computer is located.

### DETAILED DESCRIPTION OF THE PREFERRED EMBODIMENT

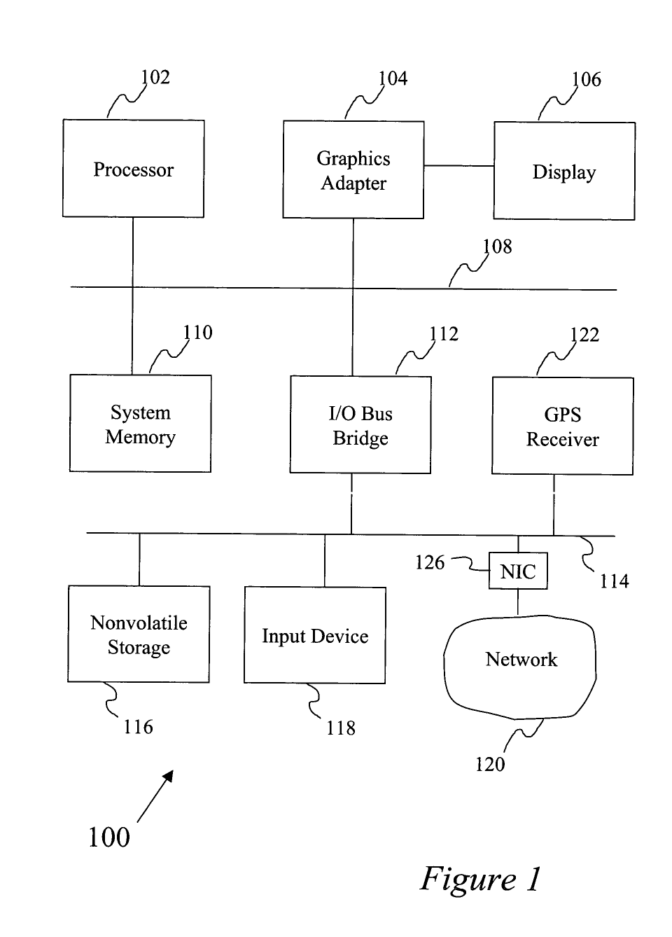

With reference now to the figures and, in particular, to FIG. 1, there is depicted a block diagram of a data processing system in which a preferred embodiment of the present invention may be implemented. Data processing system 100 may be, for example, one of the models of personal computers available from International Business Machines Corporation of Armonk, N.Y. Computer system 100 may be a desktop, a laptop or a similar computer having a full-sized computer display 106, or is a device having a small computer display 106, such as a Personal Digital Assistant (PDA), a handheld computer, a tablet computing device, a wearable computer or an Internet appliance. Data processing system 100 includes a processor 102, which is connected to a system bus 108. In the exemplary embodiment, data processing system 100 includes a graphics adapter 104 also connected to system bus 108, receiving information for display 106.

Also connected to system bus 108 are system memory 110 and input/output (I/O) bus bridge 112. I/O bus bridge 112 couples I/O bus 114 to system bus 108, relaying and/or transforming data transactions from one bus to the other. Peripheral devices such as nonvolatile storage 116, which may be a hard disk drive, floppy drive, a compact disk read-only memory (CD-ROM), a digital video disk (DVD) drive, or the like, and input device 118, which may include a conventional mouse, a trackball, or the like, is connected to I/O bus 114. Computer system 100 communicates to a network 120 via a network interface card (NIC) 126 as shown.

GPS (Global Positioning System) receiver 122 detects signals from the Global Positioning System, which is an array of satellites that orbit the Earth making it possible for ground receivers to pinpoint a geographic location. The location accuracy is anywhere from 100 to 10 meters for most equipment, and in a preferred embodiment is accurate to within one (1) meter. As known to those skilled in the art of GPS technology, multiple GPS satellites, owned and operated by the U.S. Department of Defense but available for general use around the world, are in orbit at 10,600 miles above the Earth. The satellites are spaced so that from any point on Earth, at least four satellites will be above the horizon. Each satellite contains a computer, an atomic clock, and a radio. With an understanding of its own orbit and the clock, each satellite continually broadcasts its changing position and time. GPS receiver 122 triangulates the geographic position of computer 100, either using the computing power of either processor 102 or a dedicated processor (not shown) within GPS receiver 122, by obtaining bearings from multiple satellites. The result is provided in the form of the geographic position—longitude and latitude—that is accurate within 1 to 100 meters. In a preferred embodiment, an additional satellite's signal is received to compute the altitude as well as the geographic position of computer 100.

The exemplary embodiment shown in FIG. 1 is provided solely for the purposes of explaining the invention and those skilled in the art will recognize that numerous variations are possible, both in form and function. For instance, data processing system 10 might also include a sound card and audio speakers, and numerous other optional components. All such variations are believed to be within the spirit and scope of the present invention.

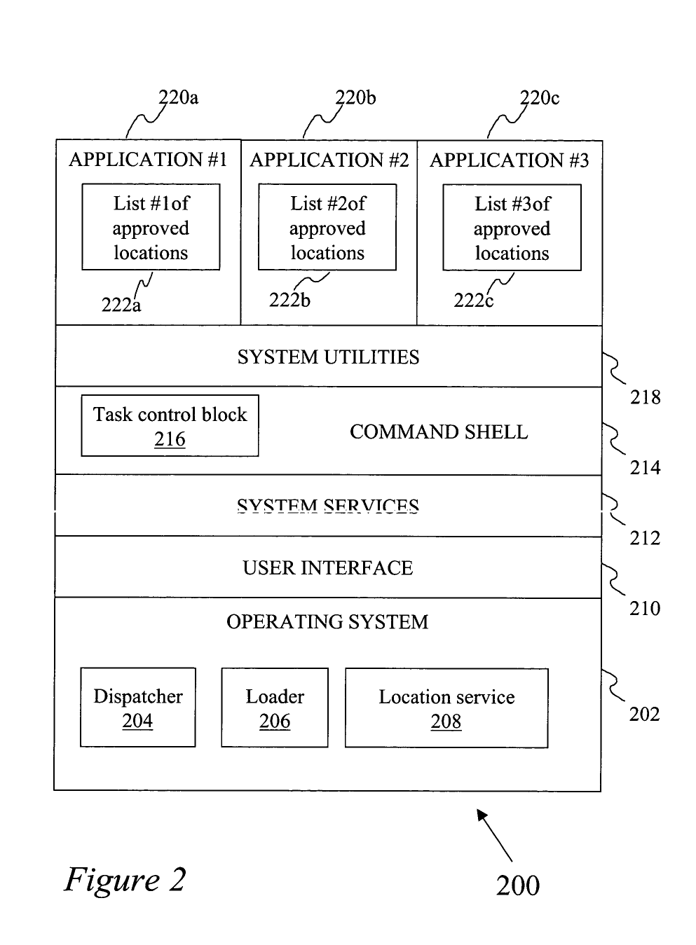

Referring now to FIG. 2, there is illustrated the multiple layers of software preferably present in system memory 110 of computer system 100 of FIG. 1. As illustrated, system memory 110 includes an operating system 202, which in a preferred embodiment of the present invention includes a dispatcher 204, a loader 206, and a location service 208. Dispatcher 204, which is part of the kernel of operating system 202, includes interrupt handlers, and ensures that processes that are ready to run are timely run by loading instructions in a processor for execution. Loader 206 loads an application into system memory from secondary non-volatile memory.

Location service 208 determines whether a particular software application is authorized to be loaded into system memory, based on the physical location of the computer at the time of the load request. Location service 208 receives a real-time GPS coordinate from GPS receiver 122 (shown in FIG. 1), indicating the precise location of computer 100. Location service 208 then compares the real-time GPS coordinate with a list of approved locations 222 that is associated with a called application 220. If the real-time GPS coordinate is within a range of locations found in a list 222, then the requested application 220 is permitted to load from nonvolatile storage 116 into system memory 110, from which it can execute. If the real-time GPS coordinate is not within the range of locations found in a list 222 associated with the requested application 220, then the requested application 220 is not loaded into system memory 110, and thus cannot run.

Next, a user interface level 210 is depicted. User interface level 210 typically provides user interface controls such as window, menus, alert boxes, dialog boxes, scroll bars, buttons, and the like. Also depicted in FIG. 2 are system services level 212 and command shell level 214. System services level 212, where provided, typically includes built in data base query languages and similar services. Command shell level 214 provides Application Program Interface (API) command line interfaces and may include the provision of certain graphical user interfaces. Command shell level 214 also includes task control block 216, which coordinates an execution of instructions in an application 220 under the control of dispatcher 204. System utility level 218 provides file copy and other similar functions.

Finally, as illustrated, multiple applications 220a-c are depicted. Such applications may include word processors, spreadsheets, graphics, programs, games or the like, but more significantly include security sensitive applications, such as bulk encryption programs or other programs that contain proprietary programming code or sensitive data (enterprise trade secrets or national security secrets). Each application 220 contains or is associated with a corresponding list of approved locations 122, which describe the geographical locations in which the associated application is authorized to run. Thus, list 222a contains a range of GPS coordinates in which the computer must physically be located in order to permit application 220a to be loaded into system memory for execution.

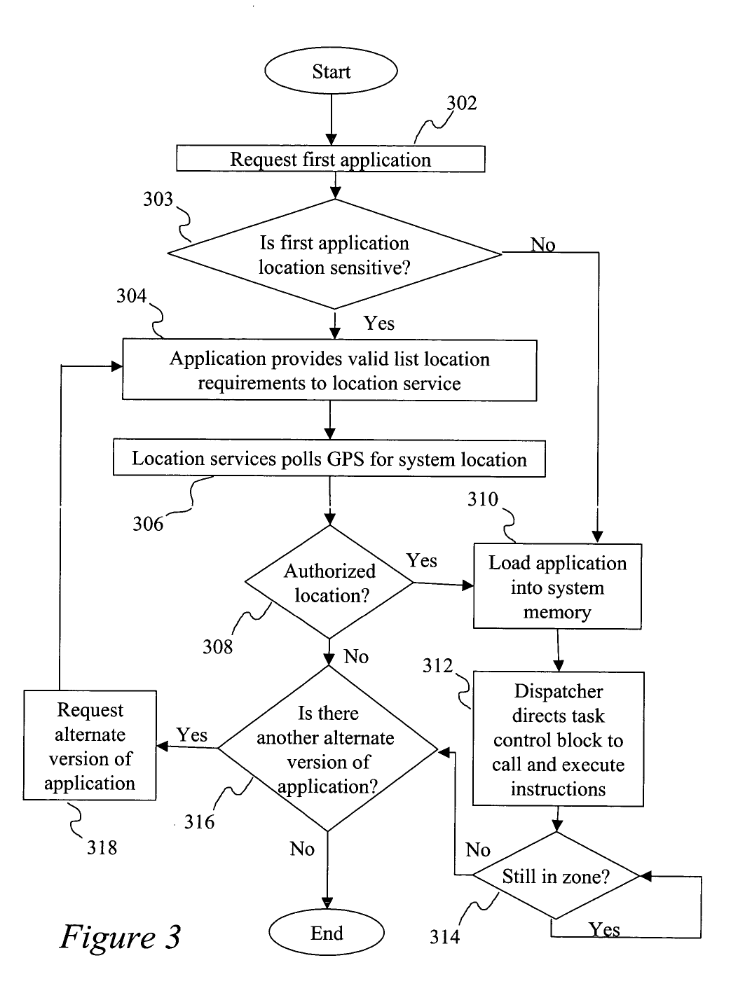

With reference now to FIG. 3, there is depicted a flow-chart of a preferred embodiment of the present invention. Starting at block 302, a computer requests a first application. A query is made (block 303) as to whether the first application requested is location sensitive. If not, then the application is allowed to be loaded and run, assuming no other security features, such as password protection, retina scan inputs, etc. If the first application requested is location sensitive, then the application provides to a location service in the computer's operating system a list of physical locations in which the application is authorized to run (block 304). The location service polls a GPS receiver or other enterprise-wide location identifier to determine the current real-time location of the computer (block 306). The location service compares GPS coordinates with the list of authorized locations for the first requested application to determine if the current location is authorized (decision block 308). If the computer is in a location where the first application is authorized to run, then the first application is loaded into system memory from non-volatile memory (block 310), and the dispatcher directs the processor via the task control block to call and execute application instructions (block 312). A query is made (query block 314) confirming that the computer is still in an authorized location. If not, the application is deleted from system memory or otherwise disabled until the computer returns to an authorized location.

If a determination was made at decision block 308 that the computer was not in an authorized location to run the requested first application, a query (query block 316) is made as to whether an alternate version of the requested first application is available for execution in the current physical location. For example, the first application may have been a 128-bit bulk encryption program, and an alternate application may be a 56-bit bulk encryption program. If such an alternate program is available, then the alternate program is requested (block 318), and the alternate program determines if it is authorized to execute in the present physical location (back up to block 304). These steps continue and repeat until an alternative version of the application is eventually located that is authorized to execute in the computer's current physical location, or else the process ends without an application being loaded and run. It is envisioned that a single application program can be constructed incorporating two or more related alternate versions of a location sensitive application and execute the appropriate function based upon the resulting decision of block 308.

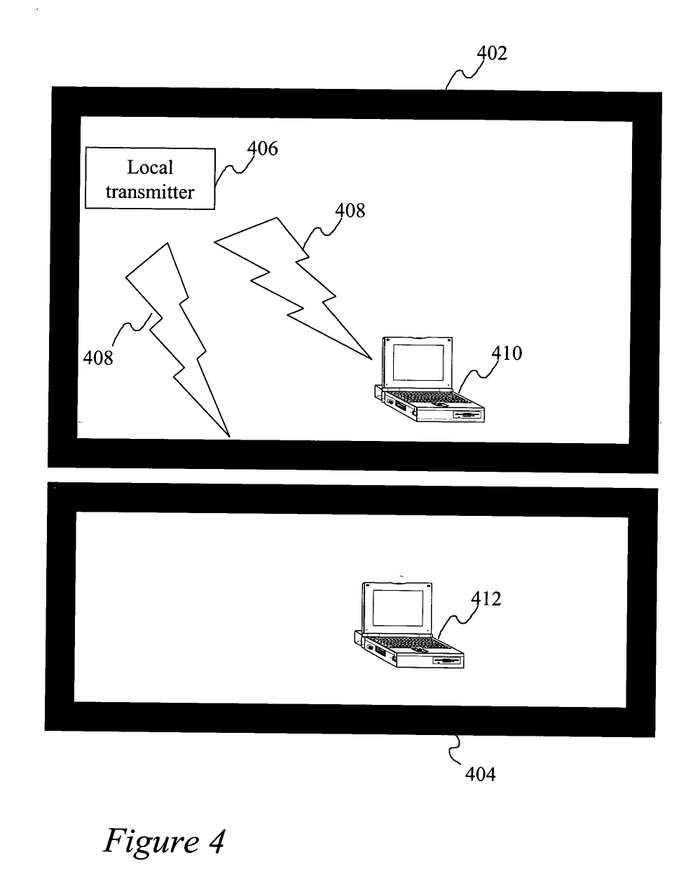

While authorized location list 222 has been describe above as relating to GPS signals, alternatively, list 222 may contain alternative coordinate listings supplied to location service 208, including a coordinate of an enterprise defined system. That is, an enterprise may have a coordinate location identifier supplied by a local transmission system. As shown in FIG. 4, an enterprise may have a location identifying system uniquely identifying each location within the enterprise's campus. For example, room 402 may be a laboratory in which a computer 410 is required to be located in order to run an application that is proprietary to the enterprise and/or operates on secret data revealed to and by the proprietary application. A local transmitter 406, operated by the enterprise, transmits a unique signal 408, preferably a digital signal, encrypted or not, that provides a unique identifier for room 402.

Computer 410, having a location receiver similar to GPS receiver 122, is therefore able to receive signal 408, which provides the prerequisite authorizing signal for loading applications that are authorized to run in room 402. Preferably, signal 408 is confined to room 402, either by the limited broadcast range of local transmitter 406, a radio frequency (RF) shield surrounding room 402, or by other means that restrict an interpretable version of signal 408 to room 402. Thus, computer 412 in room 404 is unable to receiver and/or interpret signal 408, making computer 412 unable to load an application that is only authorized to run in room 402.

In an alternate embodiment, local transmitter 406 is a repeater transmitter that repeats a true GPS signal received from a land-line, assuming that the GPS signal cannot penetrate room 402. Thus, if the GPS signal provides adequate resolution, the GPS signal may be used to be compared with the GPS based list of authorized locations down to the room level.

Alternatively, location service 208 may be structured such that the presence or lack of a GPS signal either enables or prohibits the loading of an application. Thus, an application may be constructed such that if the GPS receiver 122 does not detect a GPS signal, then it is presumed that the computer 410 is in a secure location, and the application may run. Alternatively, the application will run only with the detection of a GPS signal (or analogous enterprise-generated location signal).

It should be understood that at least some aspects of the present invention may alternatively be implemented in a program product. Programs defining functions on the present invention can be delivered to a data storage system or a computer system via a variety of signal-bearing media, which include, without limitation, non-writable storage media (e.g., CD-ROM), writable storage media (e.g., a floppy diskette, hard disk drive, read/write CD ROM, optical media), and communication media, such as computer and telephone networks including Ethernet. It should be understood, therefore in such signal-bearing media when carrying or encoding computer readable instructions that direct method functions in the present invention, represent alternative embodiments of the present invention. Further, it is understood that the present invention may be implemented by a system having means in the form of hardware, software, or a combination of software and hardware as described herein or their equivalent.

While the invention has been particularly shown and described with reference to a preferred embodiment, it will be understood by those skilled in the art that various changes in form and detail may be made therein without departing from the spirit and scope of the invention.

1. A method for regulating execution of a software according to a physical location of a computer on which the software is to be executed, the method comprising:
storing a first list of authorized location ranges where a computer is authorized to execute a first software;
determining a physical location of the computer;
comparing the physical location of the computer with the first list of authorized location ranges; and
executing the first software only if the physical location of the computer is within a range of one of the authorized location ranges from the first list of authorized location ranges.

2. The method of claim 1, further comprising:
upon determining that the physical location of the computer is not within the first list of authorized location ranges, requesting execution of a second software, the second software having a second list of authorized location ranges;
comparing the physical location of the computer with the second list of authorized location ranges, and
executing the second software only if the physical location of the computer is within a range of one of the authorized location ranges from the second list of authorized location ranges.

3. The method of claim 1, further comprising:
upon determining that the computer is not located within an authorized area, generating an alert to a software administrator server of the unauthorized area in which the computer is located while attempting to execute a restricted software.

4. The method of claim 1, further comprising:
rechecking the physical location of the computer after the first software has executed; and
upon determining that the computer is no longer in an area authorized for executing the first software, disabling the first software.

5. The method of claim 4, wherein the disabling of the first software is performed by deleting the first software from the computer's system memory.

6. The method of claim 1, wherein the physical location of the computer is determined from a Global Positioning System (GPS) signal.

7. The method of claim 1, wherein the physical location of the computer is determined from a local enterprise generated signal.

8. The method of claim 7, wherein the local enterprise generated signal is confined to a single room.

9. A system for regulating execution of a software according to a physical location of a computer on which the software is to be executed, the system comprising:
means for storing a first list of authorized location ranges where a computer is authorized to execute a first software;
means for determining a physical location of the computer;
means for comparing the physical location of the computer with the first list of authorized location ranges; and
means for executing the first software only if the physical location of the computer is within a range of one of the authorized location ranges from the first list of authorized location ranges.

10. The system of claim 9, further comprising:
means for, upon determining that the physical location of the computer is not within the first list of authorized location ranges, requesting execution of a second software, the second software having a second list of authorized location ranges;
means for comparing the physical location of the computer with the second list of authorized location ranges, and
means for executing the second software only if the physical location of the computer is within a range of one of the authorized location ranges from the second list of authorized location ranges.

11. The system of claim 9, further comprising:
means for, upon determining that the computer is not located within an authorized area, generating an alert to a software administrator server of the unauthorized area in which the computer is located while attempting to execute a restricted software.

12. The system of claim 9, further comprising:
means for rechecking the physical location of the computer after the first software has executed; and
means for, upon determining that the computer is no longer in an area authorized for executing the first software, disabling the first software.

13. The system of claim 12, wherein the means for disabling of the first software is a means for deleting the first software from the computer's system memory.

14. The system of claim 9, wherein the means for determining the physical location of the computer includes a Global Positioning System (GPS) receiver.

15. The system of claim 9, wherein the means for determining the physical location of the computer utilizes a local enterprise generated signal.

16. The system of claim 15, wherein the local enterprise generated signal is confined to a single room.

17. A software product, residing on a computer usable medium, for regulating execution of a software according to a physical location of a computer on which the software is to be executed, the software product comprising:
program code for storing a first list of authorized location ranges where a computer is authorized to execute a first software;
program code for determining a physical location of the computer;
program code for comparing the physical location of the computer with the first list of authorized location ranges; and
program code for executing the first software only if the physical location of the computer is within a range of one of the authorized location ranges from the first list of authorized location ranges.

18. The software product of claim 17, further comprising:
program code for, upon determining that the physical location of the computer is not within the first list of authorized location ranges, requesting execution of a second software, the second software having a second list of authorized location ranges;
program code for comparing the physical location of the computer with the second list of authorized location ranges, and
program code for executing the second software only if the physical location of the computer is within a range of one of the authorized location ranges from the second list of authorized location ranges.

19. The software product of claim 17, further comprising:
program code for, upon determining that the computer is not located within an authorized area, generating an alert to a software administrator server of the unauthorized area in which the computer is located while attempting to execute a restricted software.

20. The software product of claim 17, further comprising:
program code for rechecking the physical location of the computer after the first software has executed; and
program code for, upon determining that the computer is no longer in an area authorized for executing the first software, disabling the first software.

21. The software product of claim 20, wherein the program code for disabling of the first software deletes the first software from the computer's system memory.

22. The software product of claim 17, wherein the physical location of the computer is determined from a Global Positioning System (GPS) signal.

23. The software product of claim 17, wherein the physical location of the computer is determined from a local enterprise generated signal.

24. The software product of claim 17, wherein the local enterprise generated signal is confined to a single room.
